(19) United States
(12) Patent Application Publication
(10) Pub. No.: US 2018/0055283 A1
(43) Pub. Date: Mar. 1, 2018

(54) ELECTRIC GRILL LIGHTER

(71) Applicant: ERGOBIONIK GmbH, Bottrop (DE)

(72) Inventor: Thomas KLINGBEIL, Bottrop (DE)

(21) Appl. No.: 15/668,614

(22) Filed: Aug. 3, 2017

(30) Foreign Application Priority Data
Aug. 25, 2016 (DE) 102016115843.7

(51) Int. Cl. A47J 37/07; F23Q 7/04

(52) U.S. Cl. CPC A47J 37/079; F23Q 7/04

(57) ABSTRACT

An electric grill lighter has an electrically operated heating element that is bringable into contact with charcoal, and has a grip region for handling by a user. The grill lighter is usable without a line power connection and comprises a fan, an electric motor driving the fan, and an internal power supply for the heating element and the electric motor. A nozzle delivers air from the fan that emerges at the tip of the nozzle. The heating element is translationally displaceable such that it is displaceable between an idle position in which the heating element is inside the nozzle, and a contact position in which at least a sub-region of the heating element projects out of the tip of the nozzle and is bringable into contact with the charcoal.

### CROSS-REFERENCE TO RELATED APPLICATIONS AND CLAIM TO PRIORITY

This application is related to Patent Application No. 102016115843.7 filed Aug. 25, 2016 in Germany, the disclosure of which is incorporated herein by reference and to which priority is claimed.

### FIELD OF THE INVENTION

The invention relates to an electric grill lighter, having an electrically operated heating element that is bringable at least temporarily into contact with charcoal in order to light the charcoal, and having a grip region for handling by a user.

### BACKGROUND OF THE INVENTION

Electric grill lighters, which are embodied either similarly to an immersion heater or in the manner of a heat gun, are known from practical use.

It is disadvantageous in this context that electric grill lighters of this kind have a very high electrical power consumption of more than a kilowatt, so that a line power connector is necessary for operation. Mobile use, for example in the yard, in parks, or when camping, is thus not possible or possible only in difficult circumstances.

### SUMMARY OF THE INVENTION

The object of the invention is to avoid the aforementioned disadvantages and to describe an improved electric grill lighter that is usable even without a line power connector.

This object is achieved, in an electric grill lighter of the species, in that the grill lighter on the one hand comprises a fan as well as an electric motor driving the fan, and on the other hand is equipped with an internal power supply for the heating element and for the electric motor, a nozzle furthermore being provided through which, during operation of the fan, the air delivered by the fan flows and emerges at the tip of the nozzle; and the heating element being arranged translationally displaceably in a displacement direction in such a way that it is displaceable between an idle position in which the heating element is provided inside the nozzle, and a contact position in which at least a sub-region of the heating element is arranged so as to project out of the tip of the nozzle and is bringable into contact with the charcoal.

As a result, the grill lighter can be used in such a way that firstly the heating element is displaced into the contact position and, after activation, is brought into contact with the charcoal that is to be lit. Once some embers have been produced, the heating element is displaced into its idle position and switched off. The fan is then switched on, with the result that more oxygen is delivered to the embers and they are thereby caused to burn intensely.

Advantageously, an actuation element for displacement from the idle position into the contact position can be associated with the heating element so that the heating element is easily displaceable into the contact position, for example by manual actuation on the part of the user. The actuation element can in this context encompass, for example, a pusher plate, manually actuatable by the user, that enables simple operation, for example even with a grill glove.

In a preferred exemplifying embodiment of the invention, a return element for displacing the heating element from the contact position into the idle position can be associated with the heating element. The return element can encompass at least one spring element against whose return force the heating element is displaceable from the idle position into the contact position by actuation of the actuation element, so that an 2 automatic displacement of the heating element back into the idle position occurs when actuation of the actuation element ends.

The grill lighter can preferably have an L- or Y-shaped configuration. It can thus be embodied, for example, similarly to a heat gun or to a power tool, for example a battery-operated screwdriver, drill, or the like.

According to the present invention a switch for activating the heating element and/or for activating the fan can be provided and can preferably be arranged in the region of the grip region, so that the electric grill lighter or also, as applicable, at least one of its individual functions, is activatable in controlled fashion.

Advantageously, the heating element can encompass a heat-resistant support preferably made of a ceramic material, as well as a metallic heating wire arranged thereon and preferably guided around the support, so that only a smaller heating element is usable and the support ensures sufficient stability.

In a preferred exemplifying embodiment of the invention the heating wire can be arranged in a depression or several depressions, preferably in a groove or several grooves, the depth of which advantageously corresponds approximately to the thickness of the heating wire. As a result, only the upper side of the heating wire is in contact with the charcoal and the remaining regions of the heating wire are protected, so that mechanical stress on the heating wire is reduced and limited.

The heating wire can also be guided approximately parallel to the displacement direction of the heating element, with the result that mechanical stress on the heating wire upon insertion into a dense pile of charcoal is reduced and limited.

For easier insertion, the support can also be configured in rounded, flat, or even pointed fashion at the front end.

According to the present invention a switching apparatus can be provided which deactivates the heating element when the heating element is in its idle position. This ensures that the heating element is not unnecessarily activated if it cannot be in contact with the charcoal simply because of its position in the grill lighter. If desired, however, it can nevertheless still be activatable in order to preheat the air conveyed by the fan.

Preferably a switching apparatus can be provided which deactivates the fan when the heating element is in its contact position. This ensures that the air flow of the fan does not, as a result of its cooling effect, work against the activated heating element in the context of ignition of the charcoal, or that charcoal which is already ignited does not, as a result of oxygen delivery, become so hot that the heating element can be damaged.

According to the present invention, when the switch is actuated the switching apparatus either can activate the heating element if the latter is in its contact position, or can activate the fan if the heating element is in its idle position.

In a preferred exemplifying embodiment of the invention the grill lighter can have a power consumption of less than 100 W, so that sufficient functionality is ensured with usual rechargeable batteries.

### BRIEF DESCRIPTION OF THE DRAWINGS

An exemplifying embodiment of the invention, depicted in the drawings, will be explained below. In the drawings:

FIG. 1 is a side view of an electric grill lighter according to the present invention;

FIG. 2 is a side view, partly in section, depicting the subject matter of FIG. 1 with an actuated actuation element;

FIG. 3 is a perspective detail view of the heating element in its idle position; and

FIG. 4 is a perspective detail view of the heating element in its heating position.

In all the Figures, corresponding reference characters are used for identical or similar components.

### DETAILED DESCRIPTION OF THE PREFERRED EMBODIMENT(S)

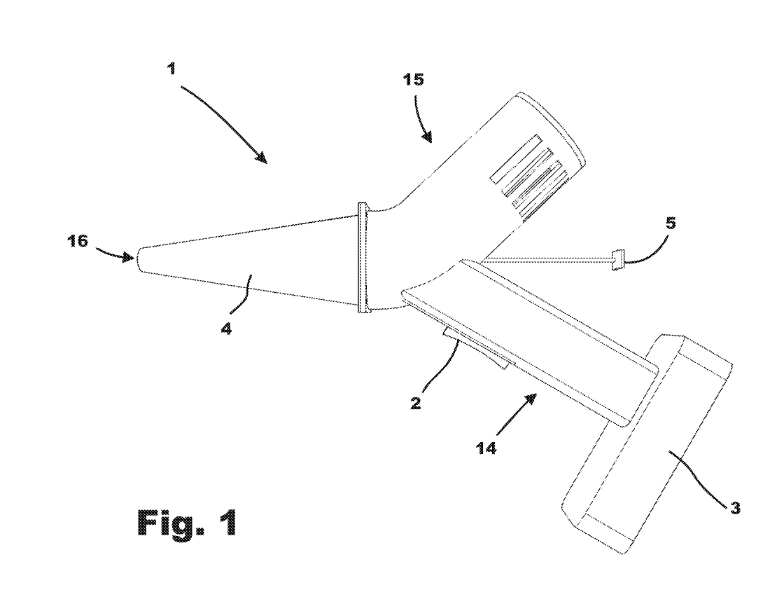

FIG. 1 shows an electric grill lighter 1 that has a Y-shaped configuration. This configuration encompasses a nozzle 4; a grip region 14 having an internal power supply, embodied as a battery 3, on the lower side; and a fan region 15 in which a fan 8, as well as an electric motor 7 driving fan 8, are provided. The configuration is similar to usual electric power tools. Battery 3 can be rechargeable and/or replaceable.

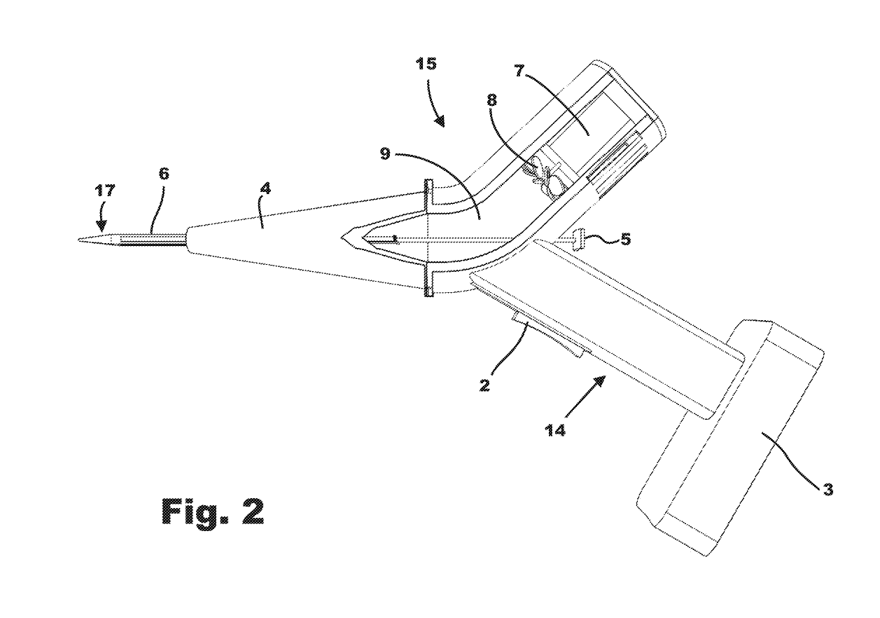

As shown in FIG. 2, during the operation of fan 8, the air delivered by fan 8 flows firstly through a conduit 9 connecting fan 8 to nozzle 4, and emerges at tip 16 of the nozzle. The shape of nozzle 4 results in a considerable acceleration of the air delivered by fan 8.

Provided in nozzle 4 is an electrically operating heating element 6 that is arranged translationally displaceably in a displacement direction in such a way that it can be displaced between an idle position in which heating element 6 is provided inside nozzle 4, and a contact position in which front sub-region 17 of heating element 6 is arranged so as to project out of tip 16 of the nozzle. When heating element 6 is activated while fan 8 is operating, the air delivered by fan 8 is preheated by heating element 6. Otherwise the heating element is cooled by the air flow.

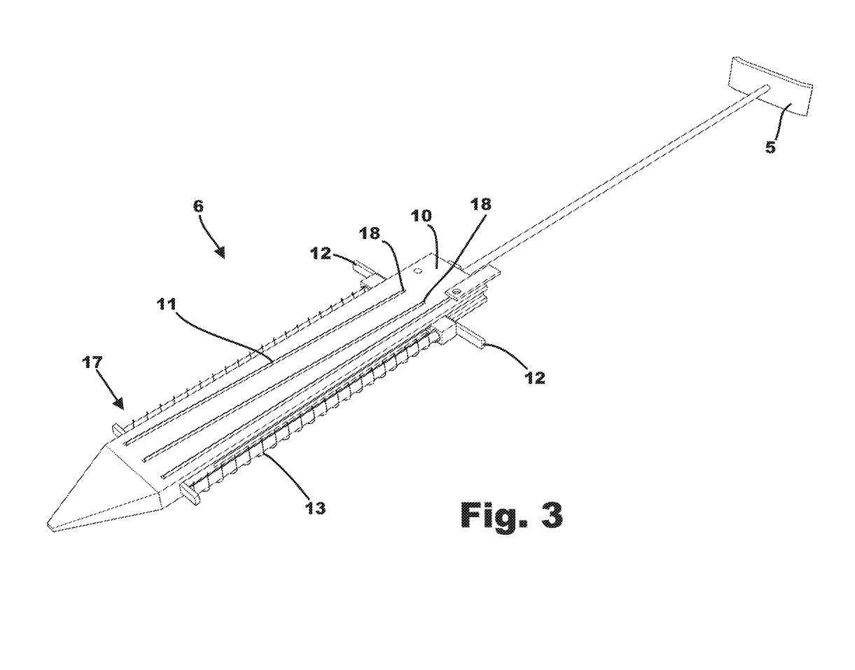

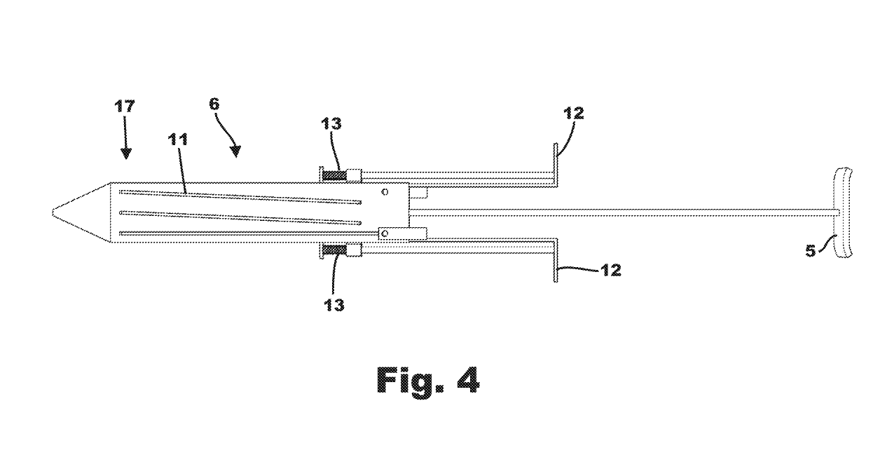

Associated with heating element 6 is an actuation element, embodied as a pusher plate 5 actuatable manually by the user, by the actuation of which heating element 6 is easily displaceable from the idle position into the contact position (see FIGS. 3 and 4).

Heating element 6 is located translationally displaceably in a frame 12 that is mounted fixedly inside the heat-resistant nozzle 4. Heating element 6 furthermore has associated with it a return element, constituted by two spring elements 13, by means of which heating element 6 is displaced from the contact position into the idle position. As a result of the return force of the spring elements, against which heating element 6 is displaced from the idle position into the contact position upon actuation of pusher plate 5, an automatic displacement of heating element 6 back into its idle position occurs when the actuation of pusher plate 5 ends.

As is evident from FIG. 3, heating element 6 encompasses a heat-resistant support 10 made of a ceramic material, as well a metallic heating wire 11, arranged thereon and guided around support 10 with several turns when viewed approximately in a longitudinal direction (which is approximately parallel to the displacement direction).

Heating wire 11 is arranged in several depressions, embodied as grooves 18, whose depth corresponds approximately to the thickness of heating wire 11.

For easier insertion into a pile of charcoal, carrier 10 is of flat and pointed configuration on the front end.

Support 10 is arranged in stationary fashion on grill lighter 1, and upon actuation of pusher plate 5, heating element 6 is displaced against the return force of spring elements 13 from the idle position (FIG. 3) into the contact position (FIG. 4). When the actuation of pusher plate 5 ends, an automatic displacement of heating element 6 back into its idle position (FIG. 3) then occurs as a result of the return force of spring elements 13.

As is evident from FIG. 1, a switch 2 for activating heating element 6 and activating fan 8, with which electric grill lighter 1 can be activated in controlled fashion, is provided in the region of grip region 14.

As a result, grill lighter 1 can be used in such a way that firstly heating element 1 is displaced into the contact position by actuating pusher plate 5, and is brought into contact with the charcoal that is to be lit. Heating element 6 is activated by pushing switch 2, and once some embers have been created, heating element 6 is displaced into its idle position, and switched off, by ending the actuation of pusher plate 5. Fan 8 is then switched on, with the result that more oxygen is delivered to the few embers already created and they are thereby caused to burn intensely.

1. An electric grill lighter (1), having an electrically operated heating element (6) that is bringable at least temporarily into contact with charcoal in order to light the charcoal, and having a grip region (14) for handling by a user,
wherein the grill lighter (1) on the one hand comprises a fan (8) as well as an electric motor (7) driving the fan (8), and on the other hand is equipped with an internal power supply for the heating element (6) and for the electric motor (7), a nozzle (4) furthermore being provided through which, during operation of the fan (8), the air delivered by the fan (8) flows and emerges at the tip (16) of the nozzle (4); and the heating element (6) being arranged translationally displaceably in a displacement direction in such a way that it is displaceable between an idle position in which the heating element (6) is provided inside the nozzle (4), and a contact position in which at least a sub-region (17) of the heating element (6) is arranged so as to project out of the tip (16) of the nozzle (4) and is bringable into contact with the charcoal.

2. The electric grill lighter (1) according to claim 1, wherein an actuation element for displacement from the idle position into the contact position is associated with the heating element (6).

3. The electric grill lighter (1) according to claim 2, wherein the actuation element encompasses a pusher plate (5) manually actuatable by the user.

4. The electric grill lighter (1) according to claim 1, wherein a return element for displacing the heating element (6) from the contact position into the idle position is associated with the heating element (6).

5. The electric grill lighter (1) according to claim 4, wherein the return element encompasses at least one spring element (13) against whose return force the heating element (6) is displaceable from the idle position into the contact position by actuation of the actuation element.

6. The electric grill lighter (1) according to claim 1, wherein the grill lighter (1) has an L- or Y-shaped configuration.

7. The electric grill lighter (1) according to claim 1, wherein a switch (2) for activating the heating element (6) and/or for activating the fan (8) is provided and is preferably arranged in the region of the grip region (14).

8. The electric grill lighter (1) according to claim 1, wherein the heating element (6) encompasses a heat-resistant support (10) preferably made of a ceramic material, as well as a metallic heating wire (11) arranged thereon and preferably guided around the support (10).

9. The electric grill lighter (1) according to claim 8, wherein the heating wire (11) is arranged in a depression or several depressions, preferably in a groove (18) or several grooves (18), the depth of which advantageously corresponds approximately to the thickness of the heating wire (11).

10. The electric grill lighter (1) according to claim 8, wherein the heating wire (11) is guided approximately parallel to the displacement direction of the heating element (6).

11. The electric grill lighter (1) according to claim 8, wherein the support (10) is configured in rounded, flat, or even pointed fashion at the front end.

12. The electric grill lighter (1) according to claim 1, wherein a switching apparatus is provided which deactivates the heating element (6) when the heating element (6) is in its idle position.

13. The electric grill lighter (1) according to claim 1, wherein a switching apparatus is provided which deactivates the fan (8) when the heating element (6) is in its contact position.

14. The electric grill lighter (1) according to claim 13, wherein when the switch (2) is actuated the switching apparatus either activates the heating element (6) if the latter is in its contact position, or activates the fan (8) if the heating element (6) is in its idle position.

15. The electric grill lighter (1) according to claim 1, wherein the grill lighter (1) has a power consumption of less than 100 W.

16. The electric grill lighter (1) according to claim 2, wherein a return element for displacing the heating element (6) from the contact position into the idle position is associated with the heating element (6).

17. The electric grill lighter (1) according to claim 3, wherein a return element for displacing the heating element (6) from the contact position into the idle position is associated with the heating element (6).
